(19) United States
(12) Patent Application Publication
(10) Pub. No.: US 2008/0067831 A1
(43) Pub. Date: Mar. 20, 2008

(54) Convertible

(75) Inventors: Dominik Beierl, Korntal-Münchingen (DE); Jürgen Ochs, Mönsheim (DE); Christian Bosk, Eppingen-Mühlbach (DE); Thiemo Adolf Erb, Stuttgart (DE); Gesine Francke, Mönsheim (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/852,496

(22) Filed: Sep. 10, 2007

(30) Foreign Application Priority Data
Sep. 8, 2006 (DE) DE102006042201.5

(51) Int. Cl. B60J 7/08; B60J 10/10

(52) U.S. Cl. 296/107.06

(57) ABSTRACT

A convertible has a top which can be opened and, in the closed state, has a headliner facing an interior of the convertible. The novel top has a rear window frame and at least two separate roof sections which, when the top is closed, are placed in front of the rear window frame in the direction of travel and, during the opening and closing of the top, can be moved in relation to each other and relative to the convertible via a top linkage. A respective, separate and self-supporting lining element which faces the interior of the convertible and which each forms a section of the headliner is disposed on each roof section.

### CROSS-REFERENCE TO RELATED APPLICATION

This application claims the priority, under 35 U.S.C. §119, of German application DE 10 2006 042 201.5, filed Sep. 8, 2006; the prior application is herewith incorporated by reference in its entirety.

### BACKGROUND OF THE INVENTION

### Field of the Invention

The present invention relates to an automobile with a convertible top—convertible, for short—with a top that can be opened and, in the closed state, has a headliner facing the interior of the convertible.

A convertible of the generic type is known from German Gebrauchsmuster (utility patent) DE 299 11 610 U1, the convertible having a flexible top at least in some regions and a rear window assigned to said top. In this case, at least one top region adjacent to the rear window is of multi-layered design and comprises a layer which forms an inside headliner facing the interior. The inside headliner is connected at its edge region, which faces the rear window, via a releasable, linear connection to a part of the rear that is connected to the rear window. By this means, the connection of the inside headliner to the edge region of the rear window is to be improved.

### SUMMARY OF THE INVENTION

It is accordingly an object of the invention to provide a convertible, which overcomes the above-mentioned disadvantages of the heretofore-known devices and methods of this general type and which provides for an improved, or at least a different, embodiment which, in particular, permits increased freedom in the designing of a headliner of a convertible top.

With the foregoing and other objects in view there is provided, in accordance with the invention, a convertible with a top movably disposed between an open state and a closed state, the top having a headliner disposed to face an interior of the convertible in the closed state of the top, the convertible comprising:

a rear window frame and at least two separate roof sections movably disposed relative to one another and relative to the convertible;

a top linkage for moving the at least two separate roof sections relative to one another and relative to the convertible, and into the closed state in which the at least two separate roof sections are disposed forward of said rear window frame in a forward direction of travel of the convertible; and

a respective, separate and self-supporting lining element disposed on each one of the roof sections, facing the interior of the convertible and forming a part of the headliner.

In other words, the invention is based on the general concept of designing a headliner, which faces an interior of a convertible, on an inside of the top in segmental form and of assigning the individual segments, which are each designed as lining elements, to a respective delimited roof section. In this case, the top has a rear window frame and at least two separate roof sections which, when the top is closed, are placed in front of the rear window frame in the direction of travel and on which such a lining element is arranged. Since a respective, separate and self-supporting lining element which each forms part of the headliner is arranged on each roof section, the respective lining element is essentially the size and the shape of the associated roof section. The respective lining element preferably lies in a sheet-like manner against the associated roof section such that the headroom of a person sitting in the convertible is maintained virtually without restriction. The convertible according to the invention therefore provides a top that has an increased level of comfort, in particular with respect to the freedom of movement in the interior of the convertible, but also at the same time provides the possibility of designing the individual lining elements in accordance with design aspects which can be freely selected. At the same time, premanufacturing of the lining elements before fitting or attachment in or on the top is also possible, thus enabling the manufacturing process of the convertible to be tightened up.

In a further advantageous embodiment, an acoustic seal is arranged in a joint between two adjacent roof sections and/or between the rear window frame and the adjacent roof section. An acoustic seal of this type reduces the level of noise within the convertible, and therefore, even at relatively high speeds and with the top closed at the same time, only slight noise annoyance penetrates from the outside into the interior of the convertible. In conventional convertibles and/or conventional tops, sonic sealing, in particular, can frequently be difficult to realize or can be realized only to an inadequate extent, since, in particular, fabric tops can only be sonically sealed with great difficulty. By contrast, the top according to the invention with the rear window frame and the at least two separate roof sections has significantly improved sound proofing in the closed state.

The two lining elements of two adjacent roof sections expediently cover a joint running between the two adjacent roof sections and at the same time prevent a view of the seal arranged in the joint. By this means, a virtually continuous, i.e. uninterrupted headliner is produced which brings about a particularly esthetic impression. At the same time, the operational safety of the top is also increased, since, when the top is closed, the joints are closed and, as a result, objects or fingers cannot enter between the individual roof sections.

In an advantageous development of the solution according to the invention, the respective lining element has a self-illuminating or illuminable surface facing the interior. For example, fluorescent films are suitable as the self-illuminating surface, while an “integrated circuit film” which illuminates under the application of an electric voltage can be used for a surface which is to be illuminated. If said self-illuminating or illuminable surface facing the interior is now additionally covered with a mask which is light-permeable at least in some regions, then a wide variety of motifs, such as, for example, a starry sky, can be realized by lighting technology, thus enabling a particular ambience to be produced in the interior of the convertible.

In a further advantageous embodiment of the solution according to the invention, the outside of the top, which faces away from the interior, is provided with a flexible covering which is continuous over the rear window frame and the at least two roof sections. This covering is preferably water-repelling and affords the advantage that it forms a closed outer skin which covers the entire top. In contrast to known foldable shell-type roofs, the problem of joints which are to be sealed between the individual roof sections can therefore be effectively avoided, which firstly simplifies the structural design of the top according to the invention and, as a result, makes it less expensive and, secondly, provides reliable protection against external weathering influences.

Other features which are considered as characteristic for the invention are set forth in the appended claims.

Although the invention is illustrated and described herein as embodied in convertible, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a longitudinal section taken through the top of a convertible according to the invention;

FIG. 2 is a view from the inside of a headliner of the top.

### DETAILED DESCRIPTION OF THE INVENTION

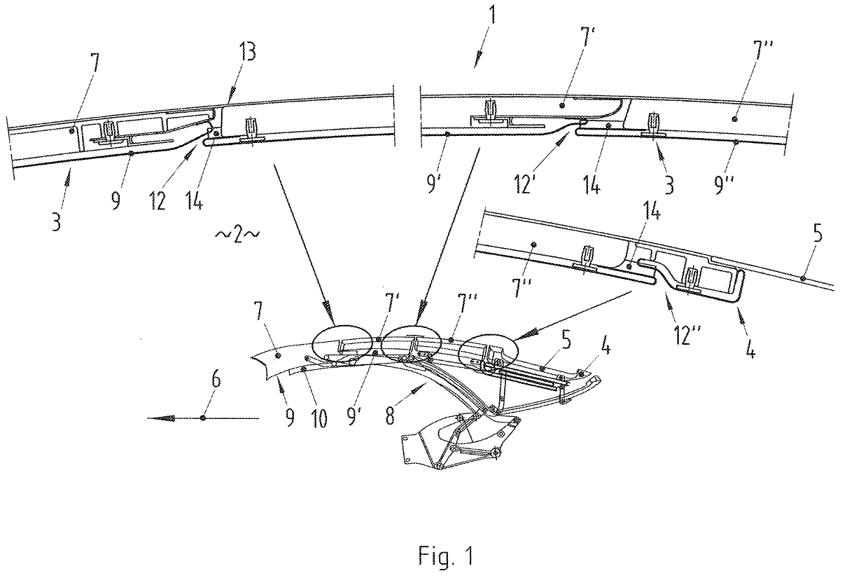

Referring now to the figures of the drawing in detail and first, particularly, to FIG. 1 thereof, a top 1 which can be opened of a convertible has, in the closed state, a headliner 3 facing an interior 2 of the convertible. The top 1 is formed with a rear window frame 4 with a rear window 5 arranged thereon, and at least two separate roof sections 7, 7′ which, when the top 1 is closed, are placed in front of the rear window frame 4 in the direction of travel 6. In the exemplary embodiment shown in FIG. 1, the top 1 of the convertible has a total of three separate roof sections 7, 7′, 7″ in front of the rear window frame 4 in the direction of travel 6. In this case, the frontmost roof section 7, as seen in the direction of travel 6, is designed as an integral roof frame while the following roof sections 7′ and 7″ are designed as first and second surface panels.

In order to open and close the top 1, the roof sections 7, 7′, 7″ can be moved in relation to one another and relative to the convertible via a top linkage 8. When the top 1 is open, the second surface panel 7″ is located below the rear window frame 4 while the integral roof frame 7 and the first surface panel 7′ are stored above the rear window frame 4.

All of the roof sections 7, 7′, 7″ and the rear window frame 4 are configured as separate elements and have a certain degree of inherent stability. The roof sections 7, 7′, 7″ and/or the rear window frame 4 can be formed from light metal, plastic or polyurethane paper honeycombs, which ensures the required degree of rigidity of the roof sections 7, 7′, 7″ and/or of the rear window frame 4. It is important in this case that the roof sections 7, 7′, 7″ and/or the rear window frame 4, firstly, are of as lightweight design as possible, in order, in particular, to be able to keep an actuator for opening and closing the top 1 small, but, secondly, have a required minimum degree of rigidity in order to provide a high level of travelling comfort.

According to the invention, a separate and self-supporting lining element 9, 9′, 9″ which faces the interior 2 of the convertible and in each case forms part of the headliner 3 is arranged on each roof section 7, 7′, 7″. A self-supporting lining element 9, 9′, 9″ of this type can be connected to the associated roof section 7, 7′, 7″, for example via a screw connection or clip connection. Since the headliner 3 is immediately visible to the passengers of the convertible sitting in the interior 2, its configuration in terms of design is of particular importance especially in higher-cost convertibles. The self-supporting lining elements 9, 9′, 9″ according to the invention therefore have a surface 10, 10′, 10″ which faces the interior 2 and can be formed, for example, from one of the following materials or can have at least one of the following materials: leather, plastic, wood, metal, fabric. This list already shows that, with the lining elements 9, 9′, 9″ according to the invention, a great degree of freedom with respect to the configuration of the headliner 3 arises, with it furthermore being conceivable that at least one surface 10 of at least one lining element 9 is kept in the color of the convertible.

It is likewise conceivable that the respective lining element 9, 9′, 9″ has a self-illuminating or illuminable surface 10, 10′, 10″ facing the interior 2. For example, a fluorescent film or coating is suitable in this case as the self-illuminating surface, while an “integrated circuit film” which illuminates when an electric voltage is applied can be used as the illuminable surface. In this case, the self-illuminating or illuminable surface 10, 10′, 10″ can be stretched over almost the entire area, facing the interior 2, of the respective roof section 9, 9′, 9″ or else the self-illuminating or illuminable surface 10, 10′, 10″ facing the interior 2 is covered at least in a partial region by a mask which is light-permeable at least in some regions, thus enabling an individual pattern of illumination to be produced. A mask 11 of this type can be configured, for example, in the form of a perforated film which covers the self-illuminating or illuminable surface 10, 10′, 10″ in such a manner that the impression of a starry sky is produced.

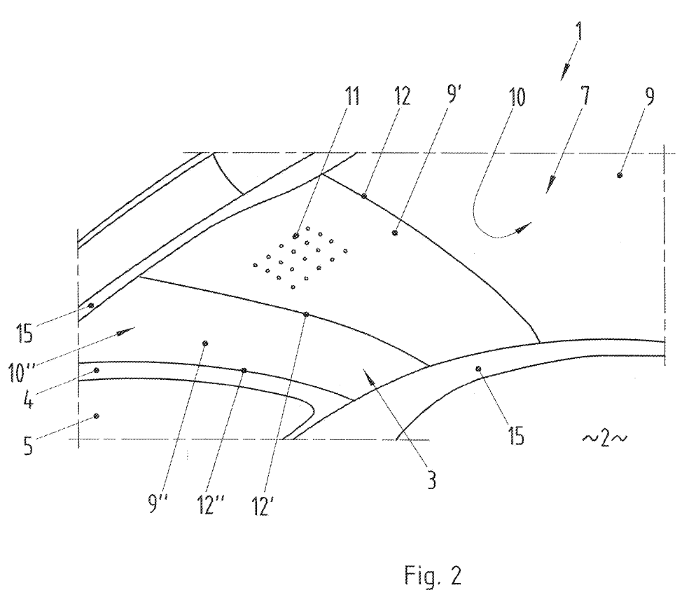

A respective joint 12, 12′, 12″ is arranged between the individual roof sections 7, 7′, 7″ and/or the rear window frame 4, as can be seen in FIG. 2, with a respective sealing element or seal 13, 13′, 13″, which is designed in particular as an acoustic seal, being provided in the respective joints 12, 12′, 12″. An acoustic seal of this type can be realized, for example, in the form of a microfiber fleece sewn into a tube. The seals 13, 13′, 13″ here are predominantly given the task of sonic sealing, since sealing against external weathering influences, such as, for example, rain or wind, is already taken on by a flexible covering 14 which forms a continuous covering over the outside, which faces away from the interior 2, of the rear window frame 4 and the roof sections 7, 7′, 7″. The covering 14 is preferably of hydrophobic design and is connected to the individual roof sections 7, 7′ and to the rear window frame 4 in such a manner that an opening movement of the top 1 is not obstructed. In particular, the covering 14 is not connected to the roof section 7″, since, during the opening of the top 1, said roof section, as mentioned at the beginning, is stored under the rear window frame 4. The covering 14 therefore means that the top 1 according to the invention is expressly not configured in the manner of a hard top.

The associated lining element 9, 9′, 9″, which preferably bears in a sheet-like manner in the region of the roof sections 7, 7′, 7″, is designed in the region of the rear window frame 4 as a self-supporting lining element 9′″ which frames the rear window 5 and forms part of the headliner 3 in the region of the rear window frame 4.

The construction of the top 1 causes, as mentioned above, joints 12, 12′, 12″ to run between the individual roof sections 7, 7′, 7″ and between the roof section 7″ and the rear window frame 4, which may, under some circumstances, have an adverse effect on the optical overall impression of the headliner 3. For this reason, the lining elements 9, 9′, 9″, 9′″ are designed in such a manner that in each case two lining elements, for example 9, 9′, of two adjacent roof sections 7, 7′ cover the joint 12 running between the two adjacent roof sections 7, 7′ and, in particular, prevent a view of the seal 13 arranged in the joint 12. This can take place, for example, by an overlapping design of the lining elements 9 to 9′″ in the region of the respective joint 12. Various overlapping variants are illustrated according to FIG. 1. In addition, it should be understood that the headliner 3 can be assigned lateral strips 15 of an elastically expandable material, such as, for example, fabric, which cover the top linkage 8 and can run from the roof section 7 and over the rear window frame 4, inclusively.

1. A convertible with a top movably disposed between an open state and a closed state, the top having a headliner disposed to face an interior of the convertible in the closed state of the top, the convertible comprising:
a rear window frame and at least two separate roof sections movably disposed relative to one another and relative to the convertible;
a top linkage for moving said at least two separate roof sections relative to one another and relative to the convertible, and into the closed state in which said at least two separate roof sections are disposed forward of said rear window frame in a forward direction of travel of the convertible; and
a respective, separate and self-supporting lining element disposed on each one of said roof sections, facing the interior of the convertible and forming a part of said headliner.

2. The convertible according to claim 1, which comprises a sealing element mounted in each case in a joint between mutually adjoining said roof sections and/or between a respective said roof section and said rear window frame.

3. The convertible according to claim 2, wherein at least one of the following is true:
said sealing element is an acoustic seal; and
said sealing element has a microfiber fleece sewn into a tube.

4. The convertible according to claim 2, wherein two said lining elements of mutually adjacent said roof sections cover the joint formed between the adjacent said roof sections and obstruct a view of said sealing element.

5. The convertible according to claim 1, wherein at least one of the following is true:
said lining elements has a surface formed of a material selected from the group consisting of leather, plastic, wood, metal, and fabric facing the interior; and
said surface of said lining elements, configured to face the interior has a color of the convertible.

6. The convertible according to claim 1, wherein the respective said lining element has a self-illuminating or illuminable surface facing the interior of the convertible.

7. The convertible according to claim 6, which comprises a mask configured to be light-permeable at least in some regions thereof, covering said self-illuminating or illuminable surface facing the interior.

8. The convertible according to claim 1, wherein the top of the convertible consists essentially of said rear window frame and three separate roof sections, and wherein, in the closed state of the top, said three separate roof sections are placed in front of said rear window frame in the forward direction of travel.

9. The convertible according to claim 1, which comprises a flexible covering disposed on an exterior of the top, facing away from the interior, said flexible covering being continuous over said rear window frame and said at least two roof sections.

10. The convertible according to claim 1, which comprises a self-supporting lining element disposed on said rear window frame and facing the interior of the convertible, said lining element framing the rear window and forming a part of said headliner.
